(19) United States
(12) Patent Application Publication
(10) Pub. No.: US 2005/0283739 A1
(43) Pub. Date: Dec. 22, 2005

(54) Method and system to improve usability of a web application by providing a zoom function

(76) Inventors: Julia Mohr, Edingon-Neckarhausen (DE); Michael Danninger, Landau (DE)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/871,647

(22) Filed: Jun. 18, 2004

(51) Int. Cl. G06F 17/00

(52) U.S. Cl. 715/800

(57) ABSTRACT

A method and system to improve usability of a web application by providing a zoom function are disclosed. In one embodiment, zoom functionality in an exemplary form of a zoom tool may be provided to allow a user to freely select a desired area of the portal screen area. The user-selected area may be utilized to indicate the portion of the portal screen to be zoomed in. In another embodiment, certain areas of the portal screen area may be zoomed in.

### FIELD OF THE INVENTION

One exemplary embodiment relates generally to service marketplace portal applications, and more particularly to a method and system to improve usability of a web application by providing a zoom function.

### BACKGROUND OF THE INVENTION

Web Applications may be run on different displaying devices like monitors, hand-held devices, mobile telephones, and other devices. Because the display area on such devices may vary, the presentation of information may be affected by the dimensions of a particular display device. For example, a personal digital assistant (PDA) has a smaller display area than a desktop computer monitor, and therefore, the amount of information that can be displayed on a PDA may be less than the amount of information that can be displayed on a desktop computer monitor. Some displaying devices may enable a user to choose from different resolution settings of a display device, which may result in an increase or in a reduction of the size of the features displayed on the displaying device.

### SUMMARY OF THE INVENTION

In one embodiment, a method and system to improve usability of a web application by providing a zoom function. According to one aspect, an interface system for a portal application is provided, the interface system including a view generator to generate an aggregate view including a plurality of display areas, each display area of the plurality of display areas being associated with a respective service accessible via the portal application; and an extractor to receive, from the user, a selection indicating a user-selected portion of the aggregate view. The view generator is configured to generate a zoom view corresponding to the user-selected portion of the aggregate view. Other features of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 is a network diagram illustrating a system having a client-server architecture, according to one embodiment of the present invention;

FIG. 2 is a block diagram illustrating a system to improve usability of a web application by providing a zoom function, according to one embodiment of the present invention;

FIG. 3 is a flowchart illustrating a method to improve usability of a web application by providing a zoom function, according to an embodiment of the present invention;

FIG. 4 is a diagrammatic representation of dataflow of a dynamic page component, according to one embodiment of the present invention;

FIG. 4A is an implementation example of a reusable software component as a Java Bean, according to one embodiment of the present invention;

FIG. 5 is a diagrammatic representation of event processing by the dynamic page component, according to one embodiment of the present invention;

FIGS. 6 and 6A illustrate an exemplary user interface to improve usability of a web application by providing a zoom function, according to one embodiment of the present invention; and

FIG. 7 is a diagrammatic representation of a computer system, within which a set of instructions, for causing the machine to perform any one or more of the methodologies discussed herein, may be executed.

### DETAILED DESCRIPTION

A method and system to generate an interface for a web application by providing a zoom function are described. In the following description, for purposes of explanation, numerous specific details are set forth in order to provide a thorough understanding of the present invention. It will be evident, however, to one skilled in the art that the present invention may be practiced without these specific details.

The zoom functionality may be a useful tool to allow a user to zoom in on a desired portion of an aggregate view, in the exemplary form of a portal screen area. The portal screen area may be an interface for a portal applcation, which in turn facilities access to a number of other applications and/or services. In one embodiment, zoom functionality in an exemplary form of a zoom tool may be provided to allow a user to freely select a desired area of the portal screen area. The user-selected area may be utilized to indicate the portion of the portal screen to be zoomed in. In another embodiment, certain areas of the portal screen area may be zoomed in.

A zoom tool may provide a zoom in functionality as well as a zoom out functionality, and be integrated into portal environment by means of, for example, providing a zoom control button, which may be located on the toolbar in the portal header. A zoom control button may be configured to allow a user to define an area (e.g., to draw a rectangle) within the portal screen indicating the area to be zoomed in, responsive to the user clicking on the zoom control button. The user-selected area of the portal screen may then be zoomed in to provide the user with a more convenient view of the selected area. In one embodiment, a zoom in control button may be provided to effectuate zoom in functionality, and a zoom out control button may be provided to effectuate zoom out functionality. A zoom tool, in one exemplary embodiment, may allow a user to perform several zoom in operations on a portal screen, each zoom in operating resulting in a zoomed in image of the respective selected portion of the portal screen. Similarly, a user may be enabled to perform several zoom out operations to access each consecutive zoomed in image in reverse order. In one embodiment, a zoom tool may include a specific control button in the tool bar or a customizable shortcut to reset a zoomed in view on the portal screen to its initial size bypassing intermediate zoomed in views. In one embodiment, a zoom tool may include a shortcut so that a user is enabled to activate a zoom function using only a keyboard.

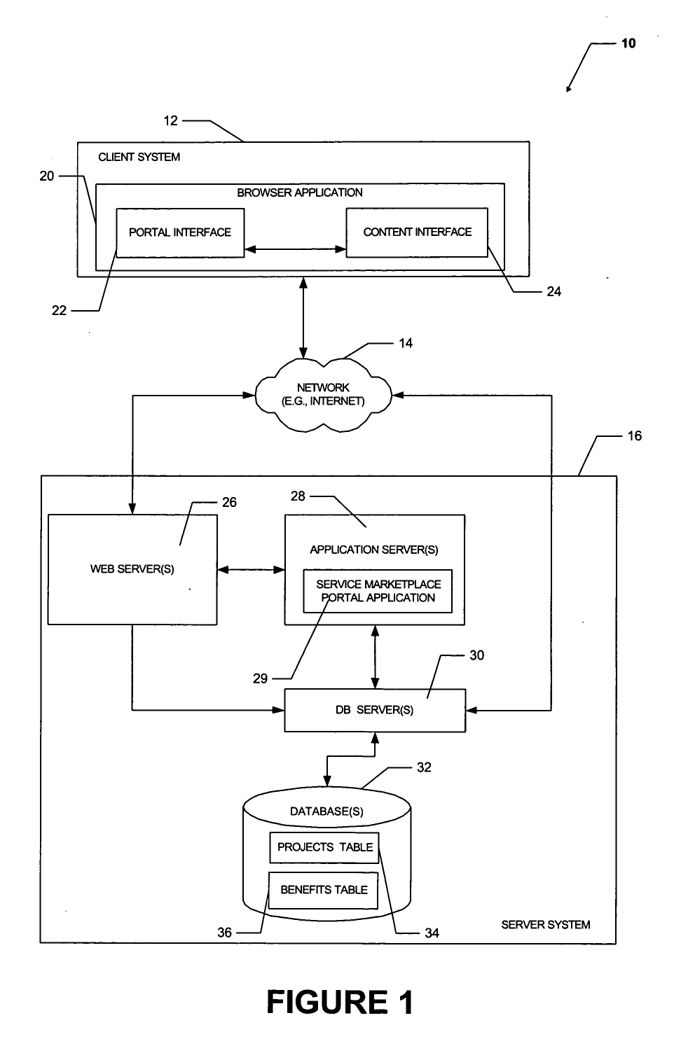

FIG. 1 is a network diagram depicting a system 10, according to one exemplary embodiment of the present invention, having client-server architecture. A client system 12 is coupled via a network 14 (e.g., the Internet or an intranet) to a server system 16, so as to facilitate communications (e.g., utilizing any one of a number of well-known network communication protocols, such as HTTP) between the client system 12 and the server system 16. In FIG. 1, the client system 12 may be any computing device, including a laptop computer, notebook computer, personal digital assistant (PDA), or handheld wireless phone. The client system 12 may further host a number of client applications, such as a browser application 20 (e.g., MS EXPLORER®, developed by Microsoft Corporation of Redmond, of Washington State). The browser application 20 may include a portal interface 22 and a content interface 24.

In one exemplary embodiment, the portal interface 22 may facilitate user access to one or more applications hosted on the application server 28, such as, for example, employee self service application, or resource and project management application.

The portal interface 22 is shown to invoke the content interface 24 within which content associated with a web-based application may be presented to a user. Specifically, the content interface 24 may communicate with the one or more applications hosted on the application server 28, at least one of which may be responsible for the delivery of content to the content interface 24. Both the portal interface 22 and the content interface 24 may communicate with the server system 16 via the network 14.

The server system 16, in one exemplary embodiment, may include a web server 26, an application server 28, and a database (DB) server 30. The database server 30 may be connected a database 32. The application server 28 may be deployed to support one or more applications, and may utilize the database server 30 to store and to retrieve data from a database 32. The database 30 may, for example, store data such as project information in an exemplary form of projects table 34, employee benefits information in an exemplary form of benefits table 36, and other information. The data within the database 32 may be stored in any one of a number of forms, such as, for example, flat files, relational tables objects, or as XML (eXtensible Markup Language) data structures. The application servers 28 may also be coupled to one or more web servers 26, so as to facilitate the delivery of web content, including content containing embedded code, such as Java, to the portal interface 22 and the content interface 24. In one embodiment, service marketplace portal application 29 resides on the application server 28.

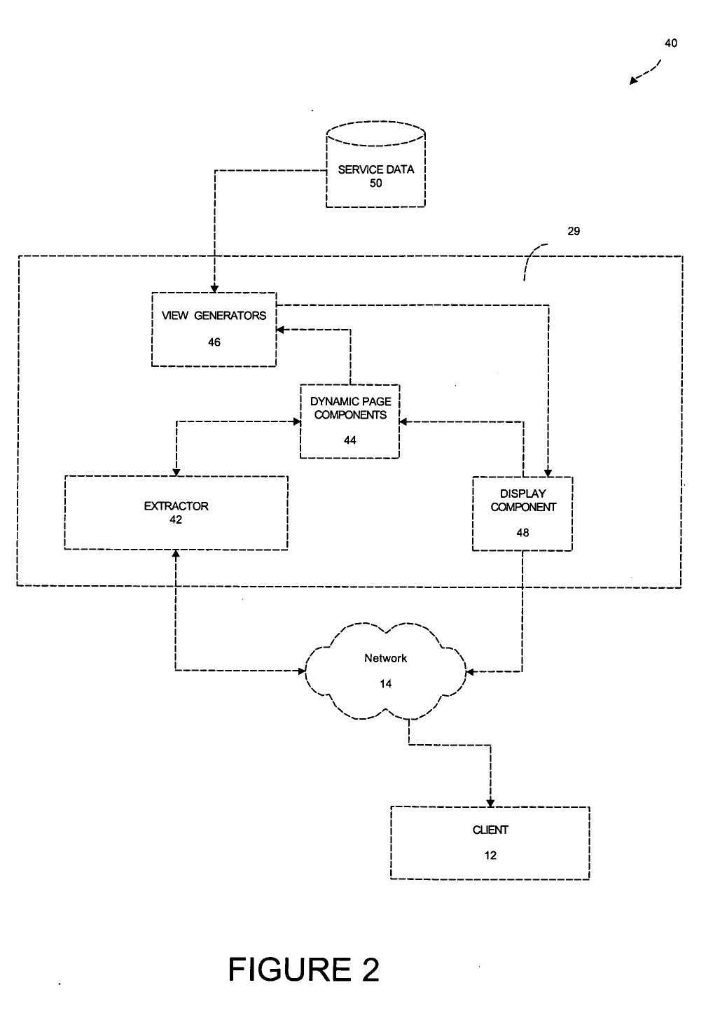

FIG. 2 is a block diagram illustrating an interface system 40 for a portal application, the interface system 40 providing a zoom function, according to one embodiment, having client-server architecture. A business platform, in the exemplary form of the service marketplace portal application 29, provides server-side functionality, via the network 14 (e.g., the Internet) to the one or more clients 12. The service marketplace portal application 29 may be configured to provide a number of business management functions and services to users.

The system 40 allows a user the client system 12 to select, either freely or by selecting predefined portions, a desired portion of the portal screen request and to zoom in and out of the desired portion of the portal screen. The service marketplace portal application 29 may include an extractor 42, dynamic page components 44, view generators 46, and a display component 48. The extractor 42 may be configured to receive a client's request for a zoom operation. The zoom operation may include a zoom in operation and a zoom out operation. A user may be provided with a zoom in control button to effectuate the zoom in operation and with a zoom out control button to effectuate the zoom out operation.

A request for a zoom operation is obtained by the extractor 42 and communicated to the dynamic page component 44. The dynamic page component 44 processes an event associated with the request for a zoom operation and enables the user to select a desired portion of the portal screen. The user may be enabled to identify a desired portion of the portal screen by drawing a rectangle on the screen indicating the desired portion of the portal screen that the user is interested in zooming in. The extractor 42 obtains the selection of a desired portion of the screen and communicates information associated with the selection to the dynamic page component 44. The dynamic page component 44 processes the request utilizing the view generator 46. The view generator 46 may be configured to access a service data database 50 and to retrieve data necessary to generate a requested view. The service data database 50, in one embodiment, may correspond to the database 32 of FIG. 1. The view generator 46 identifies information related to the selected portion of the portal screen and generates a zoom view where the zoom view includes the information contained in the selected portion of the screen such that this information fills (or occupies) the whole portal screen area. The dynamic page component 44 utilizes the zoom view generated by the view generator 46 to generate a dynamic web page, the dynamic web page including information contained in the selected portion of the screen such that this information fills the entire portal screen area. The dynamic page component 44 then delegates output to the display component 48. The display component 48 presents the user with a web page including the zoom view.

Similarly, when a user activates a zoom out button, the extractor 42 receives a request for a zoom out function and communicates the information associated with the request for a zoom out function to the dynamic page component 44. The dynamic page component 44 communicates information associated with the request for a zoomed out view to the view generator 46. The view generator 46 generates a zoomed out view. The dynamic page component 44 generates a dynamic web page utilizing the view generated by the view generator 46. The dynamic web page is then rendered to the user by the display component 48. The views may be communicated to the user in an exemplary form of HTTP pages.

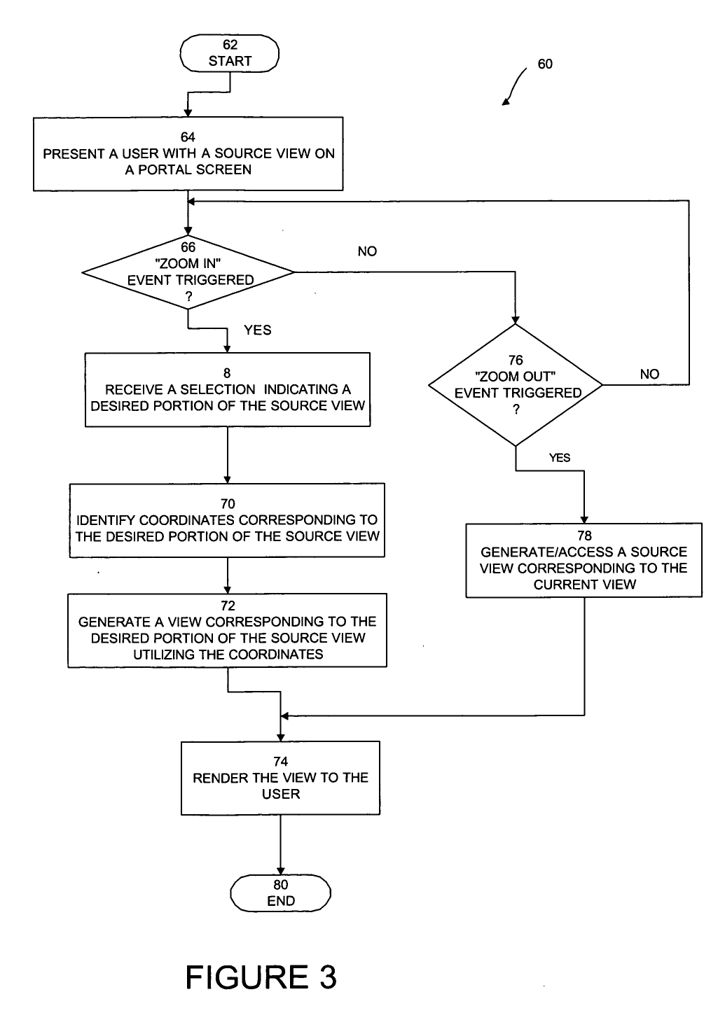

FIG. 3 is a flow chart illustrating a method 60 to generate an interface for a web application by providing a zoom function. The method 60 commences at operation 62. At operation 64, a user is presented with an aggregate view, in the exemplary form of a source view, on the portal screen. A source view may be any view that can be zoomed in and out. In one exemplary embodiment, the source view may be represented in an exemplary form of a home page (e.g., a web page related to a web service). At operation 66, the method 60 determines whether a zoom in event has been triggered. The zoom in event may be triggered responsive to a user activating a zoom in control button. A zoom in control button may be provided on a tool bar of the portal header. If it is determined, at operation 66, that a zoom in event was triggered, a user is enabled to define (e.g., to draw a rectangle) to indicate a desired portion of the portal screen. Alternatively, the dynamic page component 44 may be configured such that when the user clicks on a particular point within the portal screen, an area of the portal screen of a predetermined size is automatically zoomed in. At operation 68, the extractor 42 obtains a selection from a user identifying the desired portion of the source view within the portal screen. It will be noted that a desired portion of the portal screen (e.g., a desired portion of a source view within the portal screen) is freely selectable by a user. The selection is communicated to the dynamic page component 44. The dynamic page component 44 calculates the coordinates corresponding to the desired portion of the source view at operation 70. At operation 72, the view generator 46 generates a view corresponding to the desired portion of the source view utilizing the calculated coordinates. The view generated by the view generator 46, in this example, may be termed a zoom view. The dynamic page component 44 utilizes the view generated by the view generator 46 to generate a dynamic web page corresponding to the view generated by the view generator 46. The view (here, the zoom view) is rendered to the user utilizing the display component 48. The method 60 enables a user to zoom in on a portion of a portal screen thereby generating a zoom view, as well as to zoom out from the zoom view back to the source view corresponding to the zoom view.

At operation 76, the method 60 determines whether a zoom out event has been triggered. The zoom out event may be triggered responsive to a user activating a zoom out control button. The zoom out control button may be provided on the tool bar of the portal header. If a zoom out event was triggered, the extractor 42 receives the request for the zoom out functionality. The extractor 42 communicates the request to the dynamic page component 44, which in turn utilizes the view generator 46 to generate a dynamic page including the zoomed out view. The view generated by the view generator 46 responsive to the zoom out request from the user may be the source view or a view immediately preceding the current view. It will be noted that the source view is not necessarily a full view of the original web page. It may be one of the intermediate views if the user is enabled to zoom in on a web page repeatedly, thereby generating several zoomed views. A web page including the zoomed out view is rendered to the user at operation 74. The method 60 ends at operation 80.

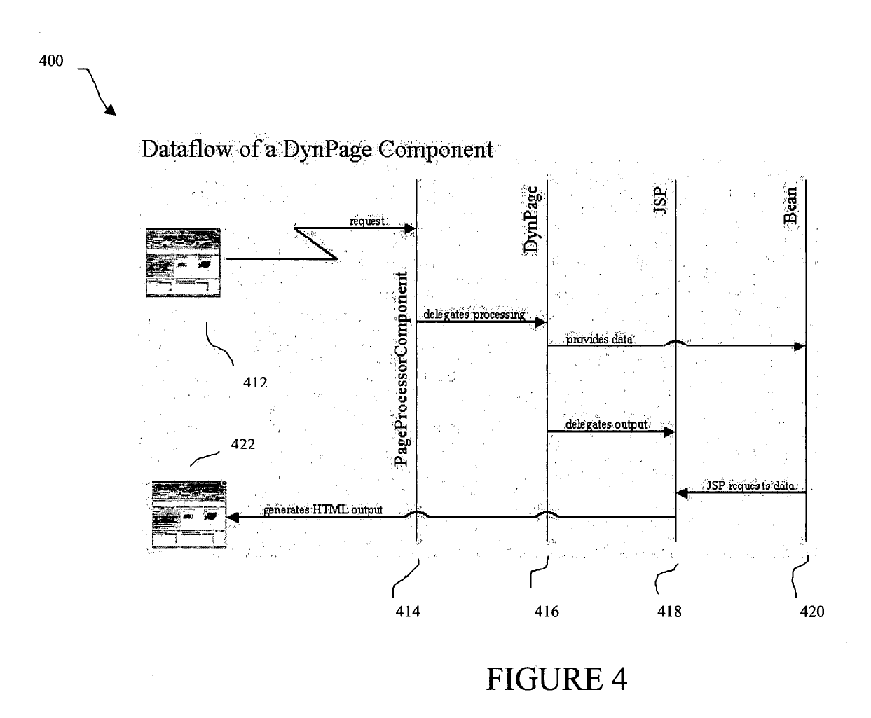

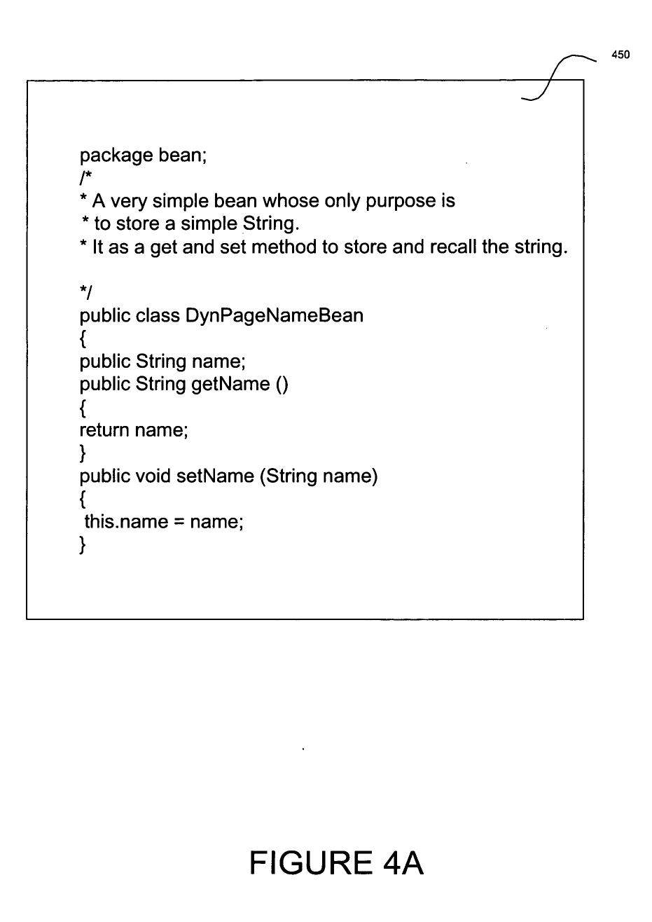

FIG. 4 is a diagrammatic representation of dataflow of the dynamic page component 44, according to one embodiment of the present invention. In FIG. 4, a request from a web page 412 is received at the page processor component 414. The request may correspond to a selection of a desired portion of the portal screen, or operation 68 in FIG. 3. The page processor component 414, in one exemplary embodiment, corresponds to the extractor 42 of FIG. 2. The page processor component 414 delegates the request processing to a dynamic page component 416. The dynamic page component 416, in one exemplary embodiment, corresponds to the dynamic page component 44 of FIG. 2. The exchange of data between the dynamic page component 416 and a JSP program 418 occurs by using a reusable software component 420. The reusable software component 420, in one exemplary embodiment, corresponds to the view generator 46 of FIG. 2, and may be implemented as a Java Bean. FIG. 4A is an implementation example 450 of the reusable software component 420 as a Java Bean.

The reusable software component 420 may be used to get and set “dynamic” data. The dynamic page component 416 may provide the reusable software component 420 with data to be utilized to generate a zoomed in view and a zoomed out view of a portal screen, and the JSP program 418 may read such data. For example a user input indicating a desired portion of a portal screen may be stored in the reusable software component 420 and then utilized when a zoomed view is displayed by the JSP program 418. Thus, the dynamic page component 416 may provide data associated with a request from the web page 412 to a reusable software component 420 (e.g., the view generator 46). The dynamic page component 416 may delegate generation of an output to the JSP program 418. The reusable software component 420 provides the requested data to the JSP program 418. Finally, the JSP program 418 generates HTML output resulting in a web page 422.

It will be noted that the exchange of data between the dynamic page component 416 and a JSP program 418 may also be effectuated utilizing a session object, a context object, or a request object.

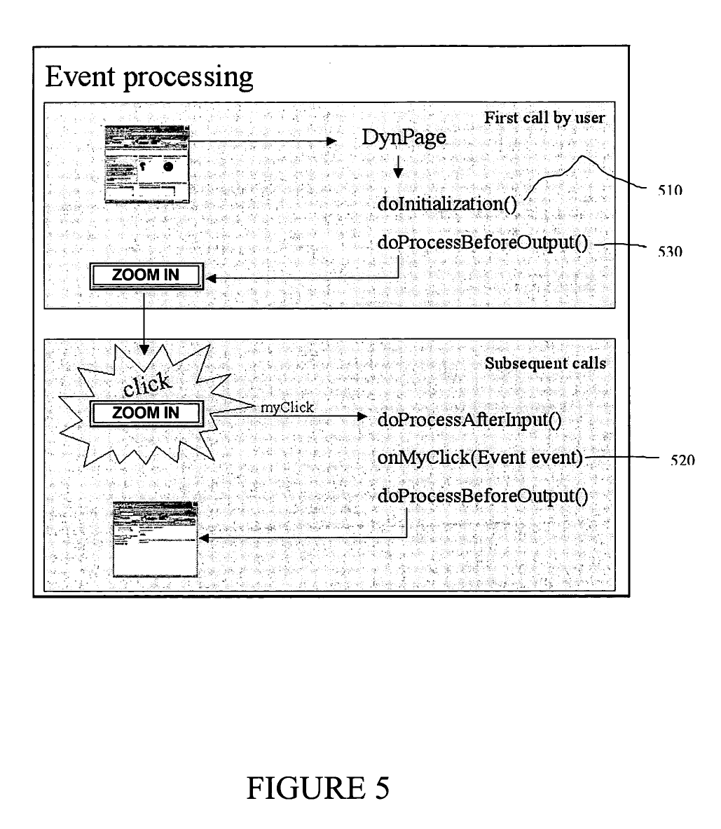

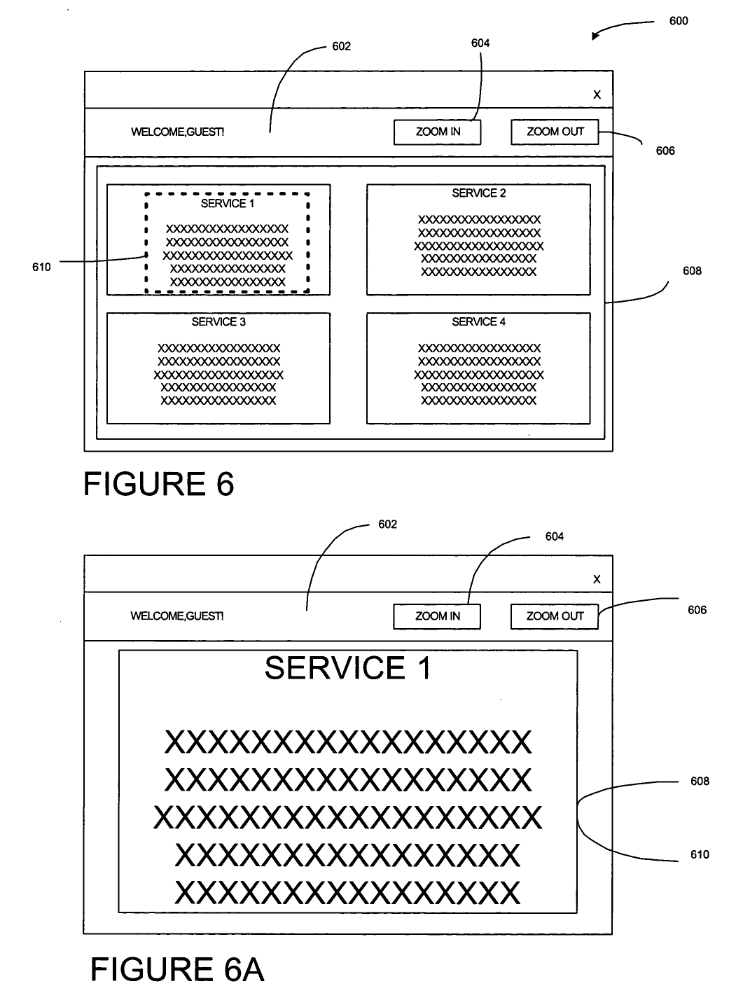

FIG. 5 is a diagrammatic representation of event processing by the dynamic page component 416, according to one embodiment. The event processing illustrated in FIG. 5 may be utilized to process the event handling methods generated by the dynamic page component 44 to allow users to zoom in on a desired portion of the portal screen area 608 (see FIGS. 6 and 6A) as described with reference to FIG. 2.

In one exemplary embodiment, the dynamic page component 416 includes an initialization method 510 (doInitialization), a processing after input method 520 (doProcessAfterInput), and a processing before output method 530 (doProcessBeforeOutput). The doInitialization method is called when the application is started. The call is made when the page is directly called per Uniform Resource Identifier (URI) without parameters and no event occurred. This method may be used to initialize data and to set up models. The doInitialization event may also be caused when another portal component on the same page sends an event. The doProcessAfterInput method is called when a web client sends a form to a web server. Except on doInitialization, the call to doProcessAfterInput is performed every time an event occurs on the client side (e.g., when a user activates a zoom control button). The doProcessBeforeOutput method is called before the form is sent to the web client. The call is performed every time even on doInitialization.

FIGS. 6 and 6A illustrate an exemplary user interface to improve usability of a web application by providing a zoom function according to one embodiment of the present invention. FIG. 6 illustrates a user interface 600. The user interface 600 may include a portal header 602 with a tool bar. The tool bar associated with the portal header 602 may include a zoom in button 604 and a zoom out button 606. The user interface 600 may further include a portal screen area 608. An area 610 indicates a desired portion of the portal screen, which may be selected by a user responsive to the user activating a zoom in button 604. In FIG. 6, information displayed within the portal screen area 608 may be referred to as a source view. Here the source view includes information related to web services, such as, for example, service 1 through service 4. The area 610 includes information related to service 1 only. FIG. 6A illustrates the portal screen area including a zoomed in view generated by the view generator 46. In FIG. 6A, the portal screen area 608 includes information related to service 1 only. The portal screen area 608 corresponds, in this example, to the area 610 selected by the user as illustrated in FIG. 6.

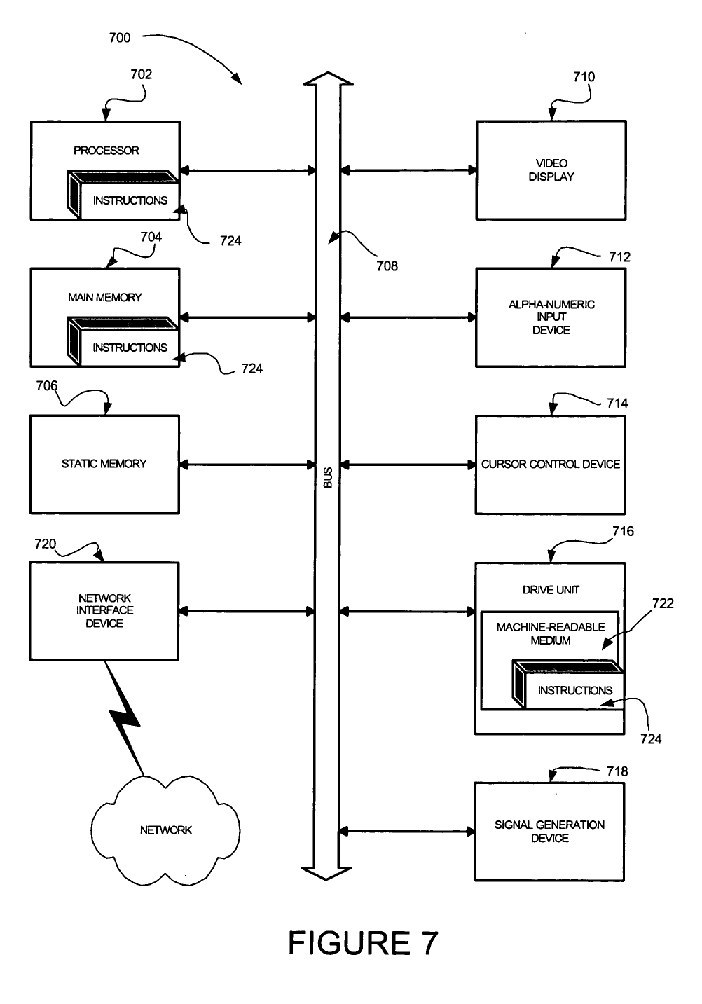

FIG. 7 illustrates a diagrammatic representation of machine in the exemplary form of a computer system 700 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 700 includes a processor 702 (e.g., a central processing unit (CPU) a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a cursor control device 714 (e.g., a mouse), a disk drive unit 716, a signal generation device 718 (e.g., a speaker) and a network interface device 720.

The disk drive unit 716 includes a machine-readable medium 722 on which is stored one or more sets of instructions (e.g., software 724) embodying any one or more of the methodologies or functions described herein. The software 724 may also reside, completely or at least partially, within the main memory 704 and/or within the processor 702 during execution thereof by the computer system 700, the main memory 704 and the processor 702 also constituting machine-readable media. The software 724 may further be transmitted or received over a network 726 via the network interface device 720.

While the machine-readable medium 722 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and system to generate an interface for a web application by providing a zoom function have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

1. An interface system for a portal application, the interface system including:
a view generator to generate an aggregate view including a plurality of display areas, each display area of the plurality of display areas being associated with a respective service accessible via the portal application; and
an extractor to receive, from the user, a selection indicating a user-selected portion of the aggregate view;
wherein the view generator is to generate a zoom view corresponding to the user-selected portion of the aggregate view.

2. The interface system of claim 1, wherein the zoom view is a scaled presentation of information included the user-selected portion of the aggregate view.

3. The interface system of claim 1, wherein the zoom view is an expanded presentation of the user-selected portion that presents information in addition to information presented in the user-selected portion of the aggregate view.

4. The interface system of claim 1, wherein a display component is to present the zoom view and the aggregate view to the user.

5. The interface system of claim 1, wherein a display component is to present the zoom view such that the zoom view fills the portal screen area.

6. The interface system of claim 1, including a dynamic page component to enable the user to switch from the zoom view to the aggregate view

7. The interface system of claim 6, wherein the dynamic page component is to receive a request to switch from the zoom view to the aggregate view responsive to a zoom out control button being activated.

8. The interface system of claim 1, including a dynamic page component is to enable the user to define the user-selected portion within the aggregate view thereby indicating the selection of the user-selected portion of the aggregate view.

9. The interface system of claim 8, wherein the dynamic page component is to enable the user to define the user-selected portion within the aggregate view responsive to receiving a request associated with activating a zoom in control.

10. The interface system of claim 1, wherein at least one user-selectable area is predefined within the aggregate view, and the interface system includes a dynamic page component is to enable the user to selected the user-selectable area as the user-selected portion within the aggregate view.

11. The interface system of claim 9, wherein the display component is to display the zoom in control in a portal header toolbar.

12. The interface system of claim 1, wherein the aggregate view is a mark-up language document.

13. The system of claim 1, wherein the zoom view is an HTML page.

14. An method including:
generating an aggregate view including a plurality of display areas, each display area of the plurality of display areas being associated with a respective service accessible via the portal application;
receiving, from the user, a selection indicating a user-selected portion of the aggregate view; and
generating a zoom view corresponding to the user-selected portion of the aggregate view.

15. The method of claim 14, wherein the zoom view is a scaled presentation of information included the user-selected portion of the aggregate view.

16. The method of claim 14, wherein the zoom view is an expanded presentation of the user-selected portion that presents information in addition to information presented in the user-selected portion of the aggregate view.

17. The method of claim 14, including presenting the zoom view and the aggregate view to the user.

18. The method of claim 14, wherein the presenting of the zoom view includes filling the portal screen area with the zoom view.

19. The method of claim 14, including enabling the user to switch from the zoom view to the aggregate view.

20. The method of claim 19, wherein the enabling of the user to switch from the zoom view to the aggregate view includes receiving a request to switch from the zoom view to the aggregate view responsive to a zoom out control button being activated.

21. The method of claim 14, including enabling the user to define the user-selected portion within the aggregate view thereby indicating the selection of the user-selected portion of the aggregate view.

22. The method of claim 21, wherein the enabling of the user to define the user-selected portion within the aggregate view is responsive to receiving a request associated with activating a zoom in control.

23. The method of claim 1, including enabling the user to select the user-selectable area as the user-selected portion within the aggregate view, wherein at least one user-selectable area is predefined within the aggregate view.

24. The method of claim 22, including displaying the zoom in control in a portal header toolbar.

25. The method of claim 14, wherein the aggregate view is a mark-up language document.

26. The system of claim 14, wherein the zoom view is an HTML page.

27. A user interface including:
a portal header to identify a web application;
a tool bar displayed within the portal header;
a portal screen area to display an aggregate view, the aggregate view representing a service offered by the web application;
a zoom in control button to enable a user to view a zoom view, the zoom view being a scaled presentation of information included the user-selected portion of the aggregate view; and
a zoom out control button to enable a user to switch from the zoom view to the aggregate view.

28. The user interface of claim 27, wherein the tool bar includes the zoom in control button and the zoom out control button.

29. A machine-readable medium having stored thereon data representing sets of instructions which, when executed by a machine, cause the machine to:
generate an aggregate view including a plurality of display areas, each display area of the plurality of display areas being associated with a respective service accessible via the portal application; and
receive, from the user, a selection indicating a user-selected portion of the aggregate view,
wherein the view generator is to generate a zoom view corresponding to the user-selected portion of the aggregate view.

30. An method including:
means for generating an aggregate view including a plurality of display areas, each display area of the plurality of display areas being associated with a respective service accessible via the portal application;
means for receiving, from the user, a selection indicating a user-selected portion of the aggregate view; and
means for generating a zoom view corresponding to the user-selected portion of the aggregate view.
